(19) United States
(12) Patent Application Publication
(10) Pub. No.: US 2011/0271788 A1
(43) Pub. Date: Nov. 10, 2011

(54) PEDAL REACTION FORCE CONTROL DEVICE

(75) Inventor: Tomoya Kawai, Susono-shi (JP)

(73) Assignee: TOYOTA JIDOSHA KABUSHIKI KAISHA, TOYOTA-SHI, AICHI-KEN (JP)

(21) Appl. No.: 13/141,026

(22) PCT Filed: Jan. 28, 2009
(86) PCT No.: PCT/JP2009/051324

§ 371 Date: Jun. 20, 2011

(51) Int. Cl. G05G 1/30

(52) U.S. Cl. 74/512

(57) ABSTRACT

A pedal reaction force control device is preferably used for performing a control of applying a pedal reaction force to a pedal. A pedal reaction force control unit performs a control of the pedal reaction force so that a constant acceleration feeling is gained by a constant pedal pressure, with respect to a change of vehicle speed. Namely, the pedal reaction force control unit performs the control so that the pedal reaction force which realizes the constant acceleration feeling becomes constant. Therefore, when a driver presses on the pedal by the constant pedal pressure in order to accelerate a vehicle, it becomes possible to appropriately realize such an acceleration that the constant acceleration feeling is gained. Thereby, it is possible to realize a feeling without decreasing an acceleration feeling.

### TECHNICAL FIELD

The present invention relates to a pedal reaction force control device which performs a control of applying a pedal reaction force to a pedal.

### BACKGROUND TECHNIQUE

This kind of technique is proposed in Patent References 1 to 3, for example. In Patent Reference-1, there is proposed a technique for performing a control so that an accelerator pedal reaction force becomes constant in a constant region in which an acceleration and a deceleration become 0. In Patent Reference-2, there is proposed a technique for maintaining a constant pedal reaction force when a pedal position does not change in such a state that the pedal is pressed on. In Patent Reference-3, there is proposed a technique for making a pedal reaction force in a sport-mode smaller than a pedal reaction force in an eco-mode.

Patent Reference-1: Japanese Patent Application Laid-open under No. 2006-117020

Patent Reference-2: Japanese Patent Application Laid-open under No. 2006-281809

Patent Reference-3: Japanese Patent Application Laid-open under No. 5-231194

### DISCLOSURE OF INVENTION

### Problem to be Solved by the Invention

By the way, generally, a mechanically generable maximum acceleration for each vehicle speed is determined in accordance with a power source and a transmission. As for a general vehicle, since the pedal reaction force is defined in accordance with an accelerator opening degree, the above maximum acceleration is set as a request acceleration so as to accelerate the vehicle, when a driver presses on the pedal by a constant pedal pressure.

Meanwhile, similarly, such an acceleration that a passenger feels a constant acceleration feeling exists for each vehicle speed, as a sensory characteristic of the passenger. Concretely, a relationship between the vehicle speed and the acceleration in which the passenger feels that the vehicle accelerates at a constant acceleration exists (hereinafter, the above feeling is referred to as “constant acceleration feeling”).

However, as for the general vehicle, such an acceleration that the passenger feels the constant acceleration feeling tends to not coincide with the above maximum acceleration. Therefore, there is a possibility that a desirable acceleration feeling for the passenger is not gained when the driver presses on the pedal by the constant pedal pressure. For example, there is a case that the passenger feels that the excessive acceleration is performed due to the acceleration exceeding such an acceleration that the constant acceleration feeling is gained.

The Patent References 1 to 3 do not disclose the control of the pedal reaction force in consideration of the constant acceleration feeling.

The present invention is made to solve the problem described above, and it is an object of the invention to provide a pedal reaction force control device capable of controlling a pedal reaction force so that a constant acceleration feeling is appropriately realized.

### MEANS FOR SOLVING THE PROBLEM

According to one aspect of the present invention, there is provided a pedal reaction force control device which performs a control of applying a pedal reaction force to a pedal, including: a pedal reaction force control unit which performs a control of the pedal reaction force so that a constant acceleration feeling is gained by a constant pedal pressure, with respect to a change of vehicle speed.

The above pedal reaction force control device is preferably used for performing the control of applying the pedal reaction force to the pedal. The pedal reaction force control unit performs the control of the pedal reaction force so that the constant acceleration feeling is gained by the constant pedal pressure, with respect to the change of vehicle speed. Namely, the pedal reaction force control unit performs the control so that the pedal reaction force which realizes the constant acceleration feeling becomes constant. Therefore, when a driver presses on the pedal by the constant pedal pressure in order to accelerate a vehicle, it becomes possible to appropriately realize such an acceleration that the constant acceleration feeling is gained. Thereby, it is possible to realize a feeling without decreasing an acceleration feeling. Meanwhile, when the driver operates the pedal so as to maintain a constant accelerator opening degree with clear intentions, it is possible to appropriately obtain a mechanically generable maximum acceleration.

In a manner of the above pedal reaction force control device, the pedal reaction force control unit performs the control of the pedal reaction force of a vehicle having a characteristic in which a mechanically generable maximum acceleration exceeds such an acceleration that the constant acceleration feeling is gained, with respect to the change of vehicle speed.

According to the above manner, it is possible to suppress an excessive acceleration without decreasing the acceleration feeling for ensuring the constant acceleration feeling. As a result, it can be expected that actual fuel consumption is improved.

### BRIEF DESCRIPTION OF THE DRAWINGS

FIG. 1 is a schematic diagram showing a configuration of a pedal reaction force control device in an embodiment.

FIG. 2 is a diagram for explaining a reason for performing a pedal reaction force control in an embodiment.

FIG. 3 is a diagram for explaining an effect when a pedal reaction force control in an embodiment is performed.

### BRIEF DESCRIPTION OF THE REFERENCE NUMBER

1 Accelerator Pedal

2 Revolution Axis

4 Reaction Force Applying Device

5 Accelerator Opening Degree Sensor

10 Controller

20 Pedal Reaction Force Control Device

### DETAILED DESCRIPTION OF THE PREFERRED EMBODIMENTS

Preferred embodiment of the present invention will be explained hereinafter with reference to the drawings.

### [Device Configuration]

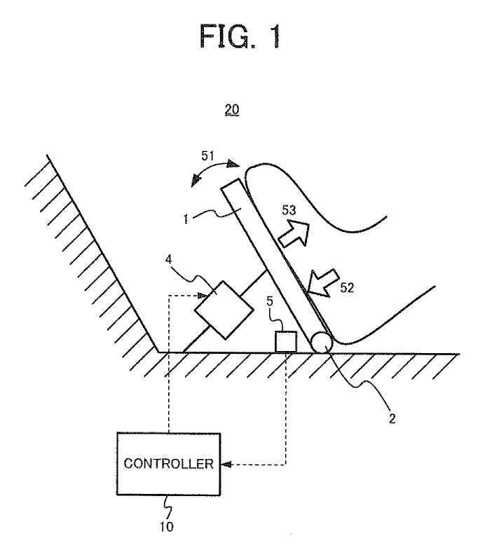

FIG. 1 is a schematic diagram showing a configuration of a pedal reaction force control device 20 in the embodiment. In FIG. 1, the broken arrow shows the input/output of the signal.

The pedal reaction force control device 20 mainly includes an accelerator pedal 1, a revolution axis 2, a reaction force applying device 4, an accelerator opening degree sensor 5 and a controller 10. The pedal reaction force control device 20 is mounted on a vehicle. In details, the pedal reaction force control device 20 is provided in lower front of a driver seat.

The accelerator pedal 1 corresponds to a foot-operated type pedal, and is operated by the driver in order to change a driving force (in other words, an engine output) which is applied to the vehicle. The accelerator pedal 1 is formed to be able to stroke in accordance with a pedal pressure of the driver as shown by a white arrow 52 (corresponding to a force which is input via a pressure surface of the accelerator pedal 1 by the pressure of the driver's foot). Concretely, as shown by an arrow 51, the accelerator pedal 1 swings on the revolution axis 2. The revolution axis 2 is provided with the accelerator opening degree sensor 5 which can detect an accelerator opening degree (pedal opening degree) corresponding to a stroke amount of the accelerator pedal 1. For example, the accelerator opening degree sensor 5 is formed by a sensor which can detect a rotation angle of the revolution axis 2. The accelerator opening degree sensor 5 provides the controller 10 with a detecting signal corresponding to the detected accelerator opening degree. Basically, as for the vehicle, by changing an opening degree of a throttle valve (which is not shown) in accordance with the accelerator opening degree, the engine output is controlled.

The reaction force applying device 4 is a device which can apply a reaction force (pedal reaction force) with respect to the stroke of the accelerator pedal 1. Here, as shown by a white arrow 53, the pedal reaction force corresponds to a force opposite to the pedal pressure applied by the driver when the driver presses on the accelerator pedal 1. Concretely, the reaction force applying device 4 is formed to be able to change the pedal reaction force applied to the accelerator pedal 1. For example, by changing a stiffness value of an elastic body (such as a spring), or by changing an air pressure, or by changing a torque and a force applied by a motor, the reaction force applying device 4 changes the pedal reaction force applied to the accelerator pedal 1. The reaction force applying device 4 is controlled by a control signal provided by the controller 10. Namely, the reaction force applying device 4 generates the pedal reaction force in accordance with the control signal provided by the controller 10.

The controller 10 is an electronic control unit (ECU) which includes a CPU (Central Processing Unit), a ROM (Read Only Memory) and a RAM (Random Access Memory), which are not shown. In the embodiment, the controller 10 functions as the pedal reaction force control unit in the present invention, and performs the control of changing the pedal reaction force applied to the accelerator pedal 1 (concretely, the controller 10 provides the control signal to the reaction force applying device 4). The pedal reaction force control performed by the controller 10 will be described in details, later.

### [Pedal Reaction Force Control]

Next, a concrete description will be given of the pedal reaction force control in the embodiment. In the embodiment, the controller 10 controls the pedal reaction force so that the constant acceleration feeling is gained by the constant pedal pressure, with respect to the change of vehicle speed. Namely, the controller 10 performs the control so that the pedal reaction force which realizes the constant acceleration feeling becomes constant.

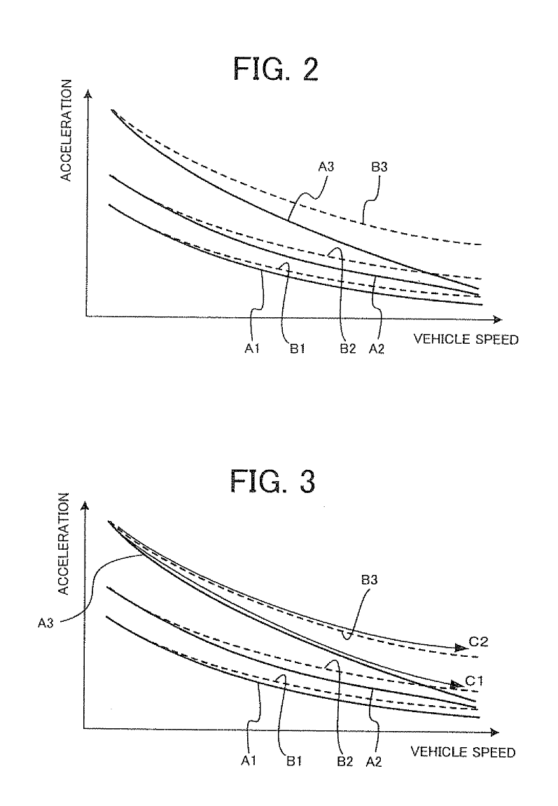

Here, a description will be given of a reason for performing the above pedal reaction force control, with reference to FIG. 2. In FIG. 2, a horizontal axis shows the vehicle speed, and a vertical axis shows the acceleration of the vehicle.

In FIG. 2, solid lines A1 to A3 (hereinafter referred to as “constant acceleration feeling line”) show examples of the relationship between the vehicle speed and the acceleration in which the constant acceleration feeling is gained. The constant acceleration feeling lines A1 to A3 are sets based on such an acceleration that the passenger feels the constant acceleration feeling for each vehicle speed, as the sensory characteristic of the passenger. Concretely, the constant acceleration feeling lines A1 to A3 correspond to the relationship between the vehicle speed and the acceleration in which the passenger feels that the vehicle accelerates at the constant acceleration. Therefore, when the acceleration which follows the constant acceleration feeling lines A1 to A3 is performed, the passenger feels that the vehicle accelerates at the constant acceleration. The constant acceleration feeling lines A1 to A3 are calculated for each vehicle by an experiment or a calculating formula, for example.

In contrast, broken lines B1 to B3 (hereinafter referred to as “constant pedal opening degree line”) show examples of the mechanically generable maximum acceleration for each vehicle speed in accordance with the power source and the transmission. As for the general vehicle, since the pedal reaction force is defined in accordance with the accelerator opening degree, the above maximum acceleration is set as the request acceleration so as to accelerate the vehicle, when the driver presses on the pedal by the constant pedal pressure. In other words, as for the general vehicle, when the driver presses on the pedal by the constant pedal pressure, the acceleration which follows the constant pedal opening degree lines B1 to B3 is performed.

In FIG. 2, the constant acceleration feeling lines A1 to A3 and the constant pedal opening degree lines B1 to B3 are shown for each accelerator opening degree. Concretely, the constant acceleration feeling line A1 and the constant pedal opening degree line B1 show the graph examples of the same accelerator opening degree, and the constant acceleration feeling line A2 and the constant pedal opening degree line 82 show the graph examples of the same accelerator opening degree, and the constant acceleration feeling line A3 and the constant pedal opening degree line 83 show the graph examples of the same accelerator opening degree. In details, the constant acceleration feeling line A3 and the constant pedal opening degree line 83 show the graph examples when the accelerator opening degree is in fully open condition.

Additionally, as shown in FIG. 2, as for the general vehicle, the constant acceleration feeling lines A1 to A3 tend not to coincide with the constant pedal opening degree lines B1 to B3, respectively. Therefore, there is a possibility that the desirable acceleration feeling for the passenger is not gained when the driver presses on the pedal by the constant pedal pressure. Concretely, as for the vehicle having the characteristic as shown in FIG. 2 in which the constant pedal opening degree lines B1 to B3 exceed the constant acceleration feeling lines A1 to A3, there is a possibility that the passenger feels that the excessive acceleration is performed due to the acceleration exceeding such an acceleration that the constant acceleration feeling is gained. Specifically, due to the need to bring out the maximum performance of the vehicle, it is difficult to reduce the acceleration which is generated when the accelerator opening degree is in fully open condition, from the mechanically generable maximum acceleration.

Thus, in the embodiment, by making the pedal reaction force coincide with the constant acceleration feeling lines A1 to A3, the pedal reaction force is controlled so that the constant acceleration feeling is gained when the driver accelerates the vehicle by the constant pedal pressure. Namely, by controlling the pedal reaction force so that such an acceleration that the constant acceleration feeling is gained is appropriately realized, the pedal operation of the driver is induced.

Concretely, the controller 10 controls the pedal reaction force so that the constant acceleration feeling is gained by the constant pedal pressure, with respect to the change of vehicle speed. Namely, the controller 10 performs the control of the pedal reaction force so that the pedal reaction force which realizes the constant acceleration feeling becomes constant. Therefore, when the driver presses on the pedal by the constant pedal pressure in order to accelerate the vehicle, it becomes possible to appropriately realize such an acceleration that the constant acceleration feeling is gained.

The controller 10 performs the above pedal reaction force control in the embodiment, when the controller 10 determines that the pedal is operated so as to accelerate the vehicle based on the detecting signal provided by the accelerator opening degree sensor 5. In this case, the controller 10 provides the control signal to the reaction force applying device 4 so as to perform the pedal reaction force control in the embodiment. While the constant acceleration feeling line is calculated for each vehicle speed by the experiment or the calculating formula as described above, the controller 10 stores the relationship between the pedal reaction force and the accelerator opening degree in which the constant acceleration feeling line is realized for each vehicle speed, and performs the control of the reaction force applying device 4 so that the pedal reaction force with respect to the accelerator opening degree is applied in accordance with the relationship.

Here, a description will be given of an effect when the pedal reaction force control in the embodiment is performed, with reference to FIG. 3. In FIG. 3, a horizontal axis shows the vehicle speed, and a vertical axis shows the acceleration. FIG. 3 shows the same graphs as the above constant acceleration feeling lines A1 to A3 and the above constant pedal opening degree lines B1 to B3 (see FIG. 2)

When the driver presses on the pedal by the constant pedal pressure (for example, the driver unconsciously operates the pedal in order to accelerate the vehicle) in case of performing the pedal reaction force control in the embodiment, the acceleration as shown by an arrow C1 is performed, for example. Namely, the acceleration which follows the constant acceleration feeling line A3 is performed. Therefore, as for the vehicle having the characteristic in which the constant pedal opening degree lines B1 to B3 exceed the constant acceleration feeling lines A1 to A3, it is possible to suppress the excessive acceleration without decreasing the acceleration feeling for ensuring the constant acceleration feeling. As a result, it can be expected that the actual fuel consumption is improved.

Meanwhile, when the driver operates the pedal so as to maintain the constant accelerator opening degree with clear intentions (in this case, the pedal reaction force becomes larger) in case of performing the pedal reaction force control in the embodiment, the acceleration as shown by an arrow C2 is performed, for example. Namely, the acceleration which follows the constant pedal opening degree line B3 is performed. In this case, it is possible to appropriately obtain the mechanically generable maximum acceleration.

### [Modification]

While the above embodiment shows the accelerator pedal 1 formed by a so-called organ type pedal (see FIG. 1), it is not limited that the present invention is applied to this. The present invention can be applied to various types of accelerator pedals such as a so-called arm type pedal.

Additionally, it is not limited that the present invention is applied to the vehicle having the characteristic in which the constant pedal opening degree line exceeds the constant acceleration feeling line (see FIG. 2 and FIG. 3). Similarly, the present invention can be applied to a vehicle having a characteristic in which the constant pedal opening degree line is below the constant acceleration feeling line, too.

### INDUSTRIAL APPLICABILITY

This invention can be used for a vehicle which can control a pedal reaction force applied to an accelerator pedal, for example.

1. A pedal reaction force control device which performs a control of applying a pedal reaction force to a pedal, comprising:
a pedal reaction force control unit which performs a control of the pedal reaction force so that a constant acceleration feeling is gained by a constant pedal pressure, with respect to a change of vehicle speed.

2. The pedal reaction force control device according to claim 1,
wherein the pedal reaction force control unit performs the control of the pedal reaction force of a vehicle having a characteristic in which a mechanically generable maximum acceleration exceeds such an acceleration that the constant acceleration feeling is gained, with respect to the change of vehicle speed.
